(19) United States
(12) Patent Application Publication
(10) Pub. No.: US 2013/0115496 A1
(43) Pub. Date: May 9, 2013

(54) ONE-PIECE HOUSING WITH PLUGS FOR PRISMATIC CELL ASSEMBLY

(71) Applicant: Johnson Controls Technology LLC, Wilmington, DE (US)

(72) Inventor: Robert John Mack, Milwaukee, WI (US)

(73) Assignee: Johnson Controls Technology LLC, Wilmington, DE (US)

(21) Appl. No.: 13/665,613

(22) Filed: Oct. 31, 2012

Related U.S. Application Data
(60) Provisional application No. 61/556,747, filed on Nov. 7, 2011.

(51) Int. Cl. H01M 2/10

(52) U.S. Cl. 429/98; 29/623.1

(57) ABSTRACT

Systems are disclosed for battery modules with housing systems. In accordance with disclosed embodiments, the housing system may include a four-walled casing (e.g., no top/bottom) with at least one hole and plug that couples with the hole in the casing using a detention mechanism. The casing may house multiple prismatic cells in a face-to-face arrangement. The plug may extend through the hole in the casing to contact and apply a compressive force to the cells within the casing. Further, the casing may have the hole and plug assembly on parallel sides, enabling the compressive force to be applied to the cells from both directions. The compressive force may retain the cells in the casing and limit the swelling of the cells to maintain their product life. The housing system may also include a cooling system in contact with the bottom of the cells and/or compression plates to distribute the compressive force evenly on the prismatic cells.

### CROSS REFERENCE TO RELATED APPLICATIONS

This application claims priority from and the benefit of U.S. Provisional Application Ser. No. 61/556,747, entitled, “One-Piece Housing with Plugs for Prismatic Cell Assembly,” filed Nov. 7, 2011, which is hereby incorporated by reference for all purposes.

### FIELD OF THE DISCLOSURE

The present disclosure relates generally to the field of batteries and battery modules. More specifically, the present disclosure relates to a housing system for battery modules that may be used particularly in vehicular contexts, as well as other energy storage/expending applications.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Vehicles using electric power for all or a portion of their motive power may provide numerous advantages as compared to traditional vehicles powered by internal combustion engines. For example, vehicles using electric power may produce fewer pollutants and may exhibit greater fuel efficiency. In some cases, vehicles using electric power may eliminate the use of gasoline entirely and derive the entirety of their motive force from electric power. As technology continues to evolve, there is a need to provide improved power sources, particularly battery modules, for such vehicles. For example, it is desirable to minimize the complexity of battery modules to decrease the costs associated with manufacturing. It is also desirable to minimize the weight and size of the battery modules to keep the vehicle lightweight and to provide space for additional vehicle components and/or storage.

Vehicles using electric power for at least a portion of their motive force may derive their electric power from multiple individual prismatic battery cells packaged into battery modules. Unlike the cylindrical containers used to house typical batteries, prismatic containers may have a degree of structural flexibility due to the differences in geometry of the cylinder and the rectangular prism. Such flexibility poses a problem in that the prismatic cells may undergo swelling due to the buildup of pressure within the cell. Swelling may result in shifting of the internal components of the prismatic cells. For example, windings within the electrode of the prismatic cell may separate, degrading the chemical properties of the prismatic cell. Further, uncontrolled swelling of the prismatic cells may drastically decrease their efficiency and product life. Accordingly, it would be desirable to provide compression to the prismatic cells to protect their chemical integrity, and thus their efficiency and product life.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present techniques may be adapted to a wide range of settings and may be particularly well suited to vehicles deriving at least a portion of their motive force from electric power. Embodiments of the present disclosure relate to battery module housing systems that may be used to compress one or more prismatic battery cells. Such compression may prevent, or at least control or limit, the amount of swelling experienced by the one or more prismatic battery cells. In accordance with disclosed embodiments, the housing system may include a four-walled casing (e.g., having no top/bottom) with a hole through one or both ends of the casing that accepts a plug. Multiple prismatic battery cells, arranged face-to-face, may be placed within the casing with a face of an end cell adjacent to the hole. The hole and plug may having complementary detention mechanisms to enable the plug to be fixed at an axial location within the hole. As the plug translates axially through the hole towards the inner area of the casing, it may apply or compression to the cells within the casing. This casing and plug system may further function to retain the cells within the casing, while leaving the bottom of the cells exposed. In one embodiment, a cooling system (e.g., fan, plate, fins, etc) may be placed in contact with the bottom of the cells to aid in cooling the cells.

In another embodiment the battery module housing system may include a compression plate located between the hole or holes in the casing wall and the face of an end cell of the plurality of cells. As the plug extends through the hole, the plug may apply force to the compression plate which then presses against the adjacent cell. The rigidity of the compression plate may enable the compression plate to spread the force of the plug over the entire face of the cell, as opposed to a single point where the plug contacts the face of the cell. This may reduce the possibility of damaging the cell.

In certain embodiments, it may be desirable to apply compression from both ends of the battery module. Accordingly, the casing may incorporate two holes located on opposite end walls, and two plugs may be used to apply the compression to the cells within the casing, with or without the use of compression plates.

Various refinements of the features noted above may exist in relation to the presently disclosed embodiments. Additional features may also be incorporated in these various embodiments as well. These refinements and additional features may exist individually or in any combination. For instance, various features discussed below in relation to one or more embodiments may be incorporated into other disclosed embodiments, either alone or in any combination. Again, the brief summary presented above is intended only to familiarize the reader with certain aspects and contexts of embodiments of the present disclosure without limitation to the claimed subject matter.

### DRAWINGS

Various aspects of this disclosure may be better understood upon reading the following detailed description and upon reference to the drawings in which:

FIG. 1 is a perspective view of an embodiment of a vehicle having a battery module contributing all or a portion of the motive power for the vehicle;

FIG. 2 illustrates a cutaway schematic view of an embodiment of the vehicle of FIG. 1 provided in the form of a hybrid electric vehicle;

FIG. 3 is a perspective view of an embodiment of the housing system enclosing multiple prismatic cells;

FIG. 4 is an exploded view of the embodiment of the housing system of FIG. 3, having a cooling system;

FIG. 5 is an exploded view of the embodiment of the housing system of FIG. 3, having compression plates;

FIG. 6 is a top view of an embodiment of the housing system, showing the housing system having two plugs;

FIG. 7 is a top view of an embodiment of the housing system, showing the housing system having one plug;

FIG. 8 is a perspective view of an embodiment of a plug, having a ratcheting mechanism as the detention mechanism;

FIG. 9A is a perspective view of an embodiment of a plug, having a ribbed structure with a snap ring as the detention mechanism;

FIG. 9B is a top view of an embodiment of a casing incorporating the ribbed plug and snap ring; and

FIG. 10 is a side view of an embodiment of a plug, having a spring-loaded feature.

### DETAILED DESCRIPTION

The term “xEV” is defined herein to include all of the following vehicles, or any variations or combinations thereof, that use electric power for all or a portion of their vehicular motive force. As will be appreciated by those skilled in the art, hybrid electric vehicles (HEVs) combine an internal combustion engine propulsion system and a battery-powered electric propulsion system. The term HEV may include any variation of a hybrid electric vehicle, such as micro-hybrid and mild hybrid systems, which disable the internal combustion engine when the vehicle is idling and utilize a battery system to continue powering the air conditioning unit, radio, or other electronics, as well as to kick-start the engine when propulsion is desired. The mild hybrid system may apply some level of power assist to the internal combustion engine, whereas the micro-hybrid system may not supply power assist to the internal combustion engine. A plug-in electric vehicle (PEV) is any vehicle that can be charged from an external source of electricity, such as wall sockets, and the energy stored in the rechargeable battery packs drives or contributes to drive the wheels. PEVs are a subcategory of electric vehicles that include all-electric or battery electric vehicles (BEVs), plug-in hybrid vehicles (PHEVs), and electric vehicle conversions of hybrid electric vehicles and conventional internal combustion engine vehicles. An electric vehicle (EV) is an all-electric vehicle that uses one or more motors powered by electric energy for its propulsion.

As described in more detail below, disclosed herein are embodiments of battery module housing systems that may be used to compress one or more battery cells and that may be well suited to xEV applications. The cells of the battery module may be retained within a casing using a plug to hold the cells in place with respect to the casing. The plug may apply a force to the cells, placing them in compression within the casing. In addition to holding the cells in place, the compressive force may extend the life of the cells by limiting their ability to swell within the casing. Further, the use of the plug enables the amount of compressive force to be adjusted for a number of cells placed within the housing, despite variances in cell dimensions and tolerances. Furthermore, embodiments of the housing systems provided herein may include a one-piece casing. Particularly, use of a one-piece structure as the casing may create rigidity within the casing, as compared to a multi-piece casing. This may enable the one-piece casing to provide rigidity and compression for the prismatic cells when they swell during operation. Further, use of a one-piece structure reduces the part count of the battery module housing, thereby decreasing the time and cost of manufacturing associated with the battery modules.

The battery modules that include the housing system with the one-piece casing and the plug may be easily configured for use in xEVs. In certain embodiments, the xEV may include at least one battery module, and each battery module may include the housing system having the simplified design. To ensure the casing and the plug of the housing system remain coupled, the casing may have a hole for the plug to feed through, and both the plug and the hole may include detention mechanisms on their interfacing surfaces. As such, the plug may securely couple to the casing and provide the ability to apply an adjustable compressive force to the cells within the housing.

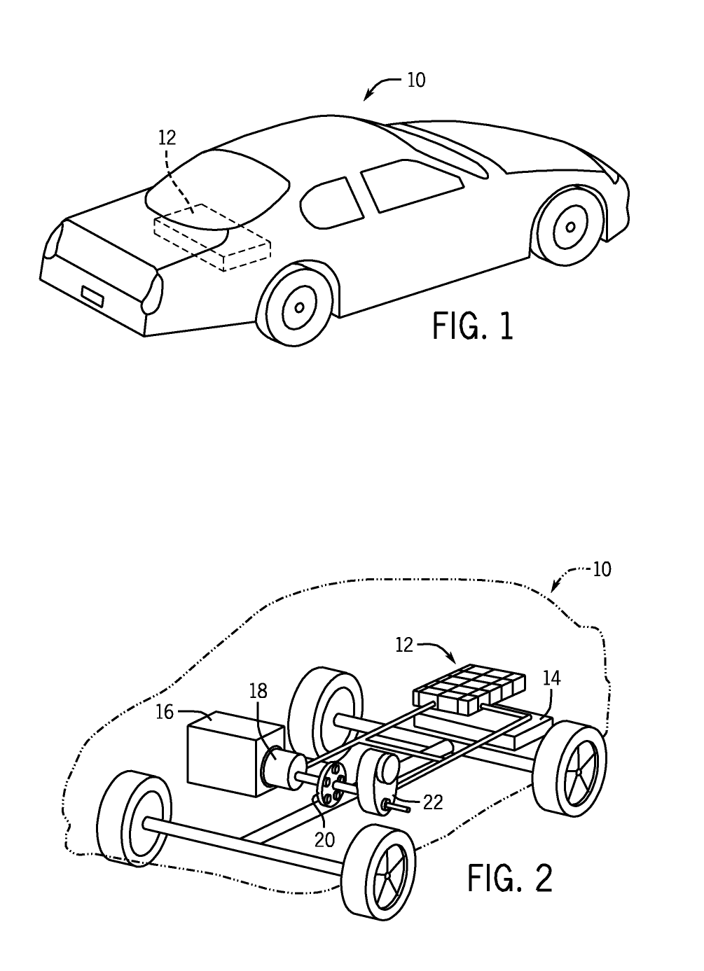

Turning now to the drawings, FIG. 1 is a perspective view of a vehicle 10 in the form of an automobile having a battery module 12 for contributing all or a portion of the motive power for the vehicle 10. The battery module 12 may be constructed from multiple individual prismatic cells and may include one or more housing systems as described above. Although illustrated as an automobile in FIG. 1, the type of the vehicle 10 may be implementation-specific, and, accordingly, may differ in other embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power. For the purposes of the present disclosure, it should be noted that the battery modules 12 and battery module accessories illustrated and described herein are particularly directed to providing and/or storing energy in xEVs. However, embodiments of the battery modules 12 having the housing system may be utilized in other, non-vehicular applications as well.

Further, although the battery module 12 is illustrated in FIG. 1 as being positioned in the trunk or rear of the vehicle 10, according to other embodiments, the location of the battery module 12 may differ. For example, the position of the battery module 12 may be selected based on the available space within the vehicle 10, the desired weight balance of the vehicle 10, the location of other components used with the battery module 12 (e.g., battery management modules, vents or cooling devices, etc.), and a variety of other implementation-specific considerations.

For purposes of discussion, it may be helpful to discuss the battery module 12 with respect to a particular type of xEV, for example, an HEV. FIG. 2 illustrates a cutaway schematic of the vehicle 10 provided in the form of an HEV. In the illustrated embodiment, the battery module 12 is provided toward the rear of the vehicle 10 near a fuel tank 14. The fuel tank 14 supplies fuel to an internal combustion engine 16, which is provided for the instances when the HEV utilizes gasoline power to propel the vehicle 10. An electric motor 18, a power split device 20, and a generator 22 are also provided as part of the vehicle drive system. Such an HEV may be powered or driven by only the battery module 12, by only the engine 16, or by both the battery module 12 and the engine 16.

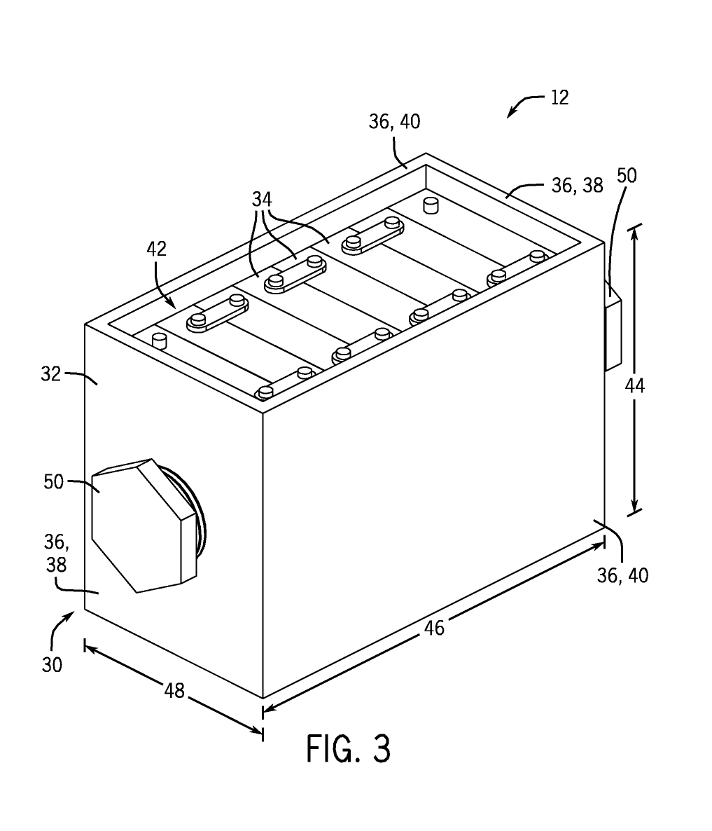

As previously described, each battery module 12 includes a housing system that encloses the cells of the battery module 12. An embodiment of such a housing system 30 is illustrated in FIG. 3. The housing system 30 generally includes an electrically insulating casing 32 that encloses one or more prismatic cells 34. The casing 32 may be designed to surround or enclose any desired number of prismatic cells 34. As can be understood, electrically insulating dividers may be placed between the cells 34 in the case that the casing 32 and/or the cells 34 are polarized. As shown, the casing 32 of the housing system 30 may be constructed from four walls 36 generally arranged as a box without a top or bottom. Of the four walls 36, two end walls 38 may be parallel to one another, and two side walls 40 may be parallel to one another, so that the walls 36 create a rectangular internal space 42 within the casing 32 that accommodates the cells 34. The end walls 38 and side walls 40 may have an equal height 44. However, a length 46 of the side walls 40 may be greater than a length 48 of the end walls 38 to accommodate multiple prismatic cells 34 in a face-to-face arrangement. The lengths 46 and 48 of the walls 36 may be adjusted to accommodate a different number or arrangement of the cells 34.

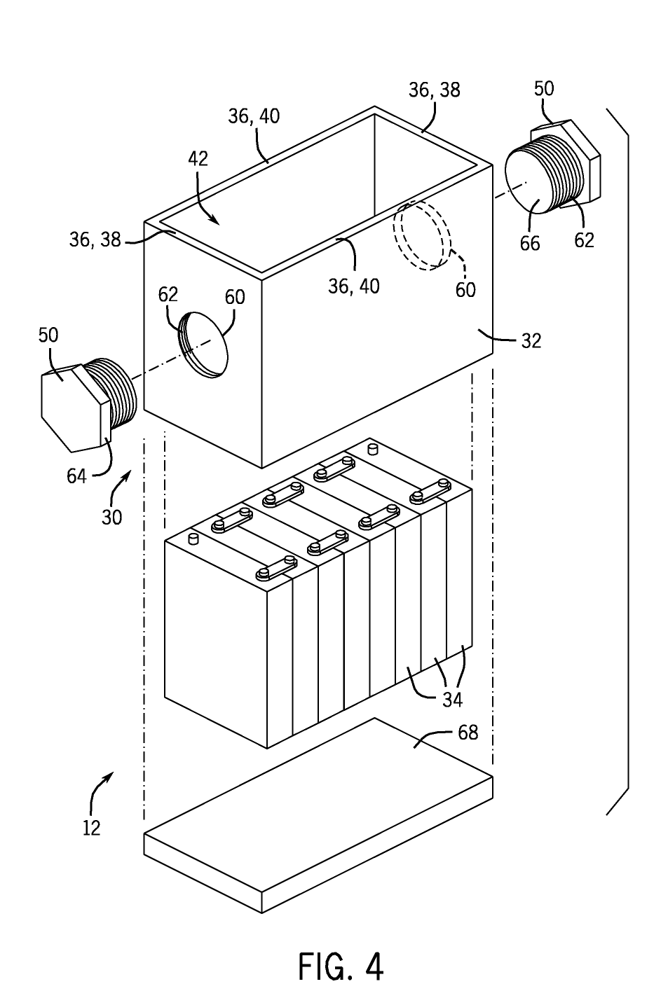

In certain embodiments, the casing 32 may be formed as a single piece. Creating the casing 32 as a single piece may increase the strength of the casing 32, thereby enabling the casing 32 to provide rigidity for the cells 34 as they swell during operation. The structural stability of the single-piece casing 32 may apply compression to the cells 34 as they swell, decreasing the possibility of changing the internal geometry of the cells 34. This may preserve the product life and efficiency of the cells 34. Further, a single-piece casing 32 decreases the part count associated with the housing system 30 and decreases the number of manufacturing steps needed to create the casing 32. For example, the one-piece casing 32 may be created in a single step by injection molding of a thermoplastic material, thereby reducing costs associated with manufacturing for the battery module 12 and making the resulting vehicle 10 more affordable for consumers. The casing 32 may be formed to include a hole (see FIG. 4) in at least one end wall 38 to accommodate a plug 50. The hole may be formed simultaneously with the casing 32 to reduce manufacturing steps/complexity. For example, polyvinyl chloride (PVC) or a similar thermoplastic may be used to form the one-piece casing 32.

To provide a better understanding of how the plug 50 and other components fit within the casing 32, FIG. 4 provides an exploded view of an embodiment of the housing system 30. As previously described, the casing 32 may include holes 60 to house the plugs 50. In the depicted embodiment, each end wall 38 includes the hole 60 at a generally central location. The holes 60 enable the plugs 50 to contact and apply compression to the cells 34. Detention mechanisms 62 on the surface of the holes 60 enable the plugs 50 to securely couple to the holes 60 and translate axially through the holes 60. This axial translation may be used to adjust the location of the plugs 36 within the holes 60, enabling the amount of compressive force applied to the cells 34 to be adjustable. It may be desirable to adjust the amount of compressive force applied to the cells 34 to enable the housing system 30 to accommodate variances within the dimensions of the cells 34. For example, if the casing 32 accommodates eight cells 34 and each cell is manufactured to a tolerance of ± 1/16^{th} of an inch, there may be up to ½ of an inch that the housing system 30 must accommodate. Accordingly, the adjustable compressive force may enable the design of the housing system 30 to be robust with respect to the tolerances and variances of the multiple prismatic cells 34.

Each plug 50 may include a head portion 64 and a body portion 66. The body portion 66 may be inserted into the hole 60 externally to the casing 32. Accordingly, the detention mechanism 62 on the body portion of the plug 50 may mate with the detention mechanism 62 in the hole 60 to couple the plug 50 to the casing 32. Although shown as matching threaded surfaces in FIG. 4, the detention mechanism 62 may utilize a ratchet and pawl system, a rib and snap-fit ring system, or another suitable system. A force and/or torque may be applied to the head portion 64 to translate the plug 50 within the casing 32, resulting in axial movement of the plug 50. As such, the distance that the body portion 66 of the plug 50 extends into the internal space 50 of the casing 32 may be adjustable, thereby enabling the plug 50 to provide adjustable compressive force to the cells 34 within the internal space 50.

The head portion 64 may have a larger cross-section than the body portion 66 and the hole 60 such that it cannot pass through the casing 32. Further, the head portion 64 may have a different geometry than the body portion 66 and the hole 60. For example, the head portion 64 may have a geometry that can withstand the force and/or torque applied to the head portion 64. For example, the head portion 64 of the plugs 50 may be fastened to the casing 32 using an automated system or by hand.

The embodiment of the housing system 30 in FIG. 4 further includes a cooling system 68. Because the casing 32 does not include a bottom piece, the cooling system 68 may have access to, or be in direct contact with, the bottom of the cells 34. Thus, the cooling system 68 may dissipate heat generated by chemical reactions within the cells 34. The use of the cooling system 68 may improve the reliability of the battery module 12 by preventing the cells 34 from overheating. The cooling system 68 may include a liquid or gas coolant circuit, a cooling plate, a heat sink, a fan, a finned structure, or a combination thereof.

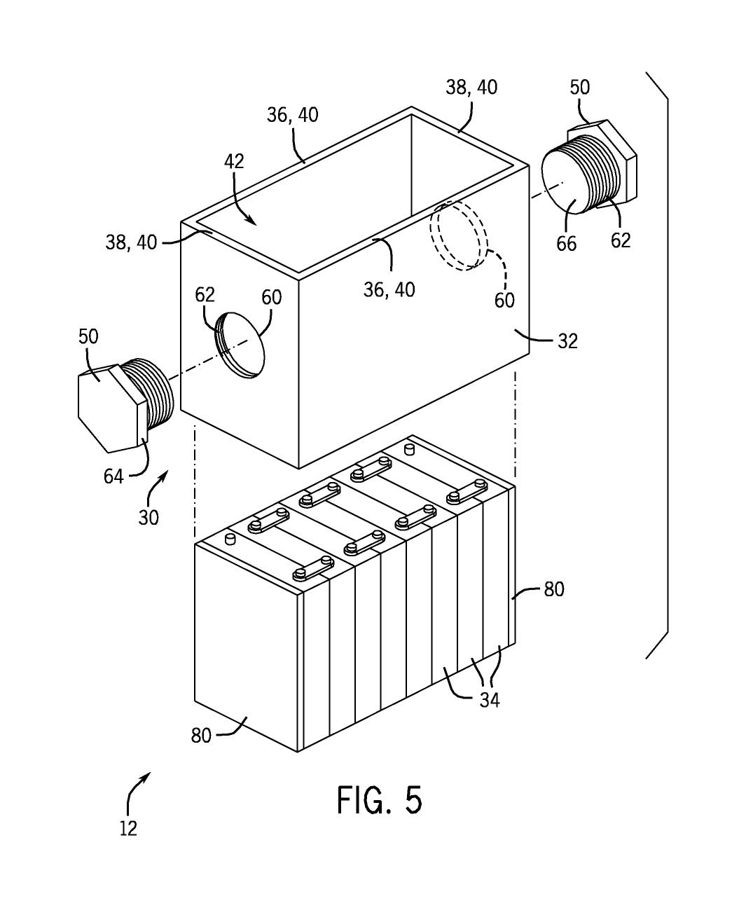

To more evenly distribute the compressive force exerted by the plugs 50, the housing system 30 may include compression plates 80. Accordingly, FIG. 5 depicts the housing system 30 with two compression plates 80. The compression plates 80 may be rigid plastic plates that are placed at each end of the face-to-face cell 34 stack. In this way, the body portion 66 of the plugs 50 may apply force to the compression plates 80 instead of applying force to the cells 34 directly. By applying the force to the rigid compression plates 80 instead of the cells 34, the compressive force from the plug 50 is applied over the entire surface area of the face of the cell 34, thereby reducing the possibility of damaging the cells 34 with the application of a concentrated force. When included in the housing system 30, the compression plates may generally be located where a plug 50 contacts a cell 34 or where a cell 34 contacts the casing 32. The compression plates 80 may be rectangular, circular, triangular, or any other suitable geometry for even force transmission. Particularly, the compression plates 80 may be included in the housing system 30 when even compressive force transmission is a primary goal of the housing system 30, as opposed to reduced part count and/or manufacturing minimization.

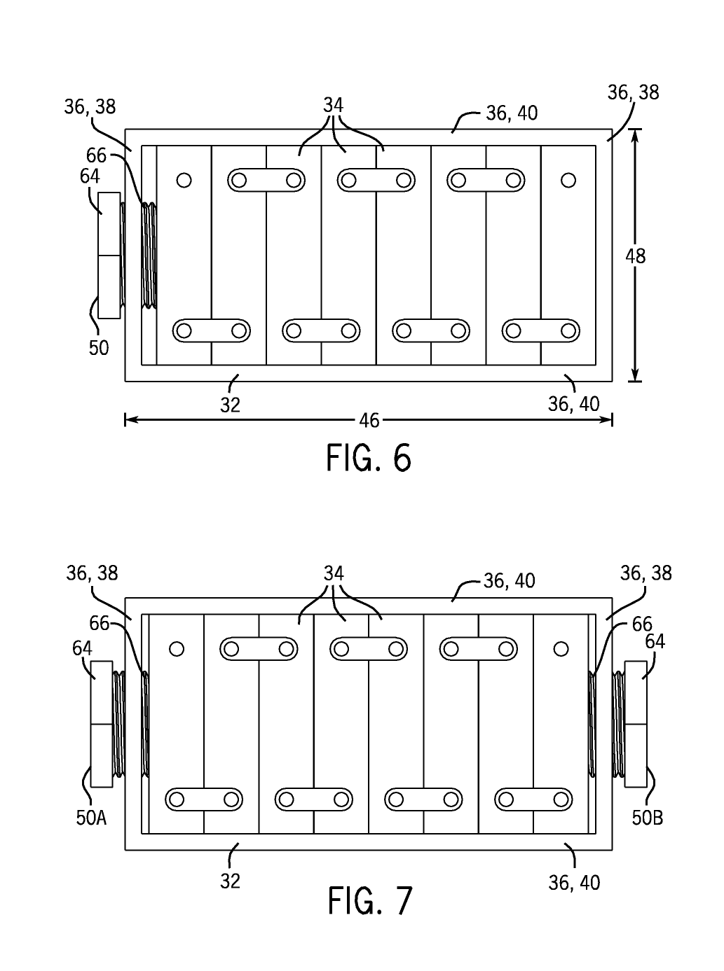

An assembled top-view of the battery module 12 is provided in FIGS. 6 and 7. These views depict how the cells 34 may fit within the components of the housing system 30. For example, the cells 34 may fit tightly within the length 46 from end wall 38 to end wall 38. Within the length 48, the fit between the cells 34 and the casing may be loose enough to allow the cells 34 to be placed into the casing 32 via the open top. In this way, any group of a set number of cells 34 may be housed within a mass-produced version of the casing 32, and slight variances in the dimensions of the cells 34 and/or the casing 32 may not affect how the cells 34 fit within the casing 32. Although not shown, the fit along the length 46 provides the option of including compression plates 80 within the casing 32. As depicted in FIG. 6, a single plug 50 applies compressive force to the cells 34 from the end wall 38. However, if it is desirable to provide increased compressive force to the cells 34, two plugs 50A and 50B may be used, as shown in FIG. 7. In alternative embodiments, multiple holes 60 and plugs 50 may be used at each end wall 38. Accordingly, the plugs 50 may vary in length depending on the number of cells 34 within the housing 32, the presence of compression plates 80 within the housing 32, the variance among cell 34 dimensions, the thickness of the end walls 40, and/or other design considerations. Further, although shown as threaded features, the plugs 50 may incorporate different detention mechanisms 62 to fix the plugs 50A and 50B within the holes 60.

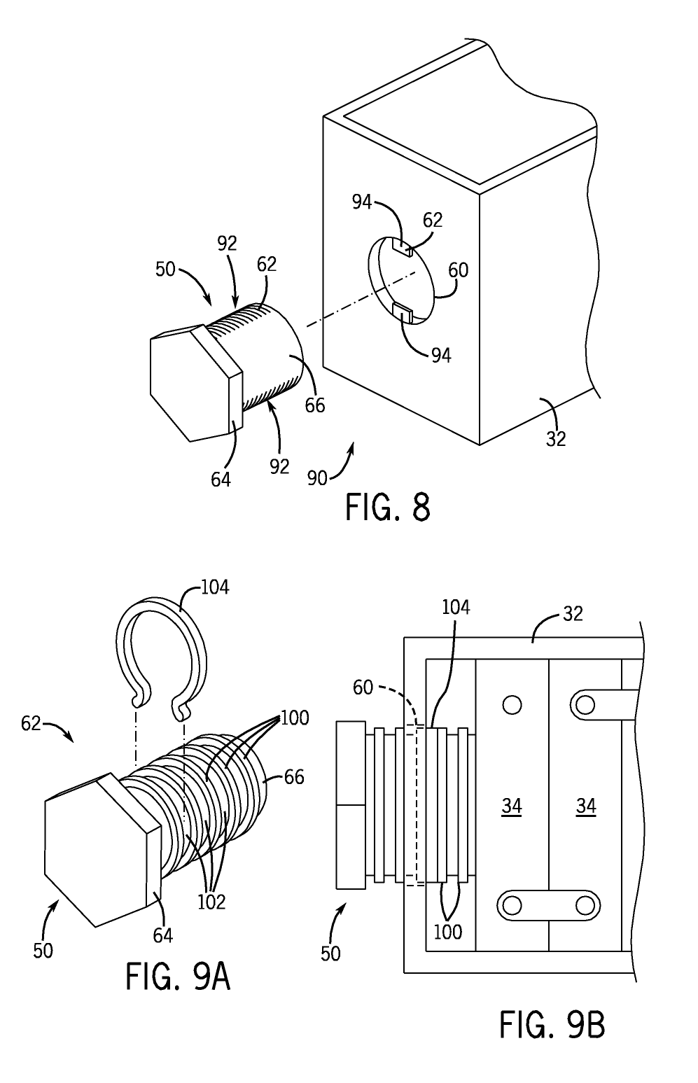

One alternative detention mechanism 62 for holding the plug 50 in place within the casing 32 may be a ratcheting system 90, as depicted in FIG. 8. For example, the body portion 66 of the plug 50 may include multiple rows of triangular teeth 92 that extend along the body portion 66 parallel to the axis for the plug 50. Each row of teeth 92 may interact with a pawl 94 disposed within the hole 60 in the casing 32. Using the ratcheting system 90, the plug 50 may only be able to translate axially into the hole 60, being fixed in position by the pawl 94. Accordingly, as the cells 34 begin to swell, the plug 50 may not back out of the hole 60, thereby applying compression to the cells 34.

In a different embodiment, depicted in FIGS. 9A and 9B, the detention mechanism 62 may utilize ribs 100 and a snap-fit ring 102 to hold the plug 50 in place within the casing 32. As shown in FIG. 9A, multiple ribs 100 may radially project from the body 66 of the plug 50. Accordingly, the space between the ribs 100 may form trenches 102. The trenches 102 may accommodate a snap-fit ring 104. In FIG. 9B, the snap-fit ring 104 is shown disposed in one of the trenches 102, such that the body portion 66 of the plug 50 is extending a desired distance into the rectangular inner space 42 of the casing 32. In this way, the plug 50 may apply compression to the cells 34 as they begin to swell within the casing 32.

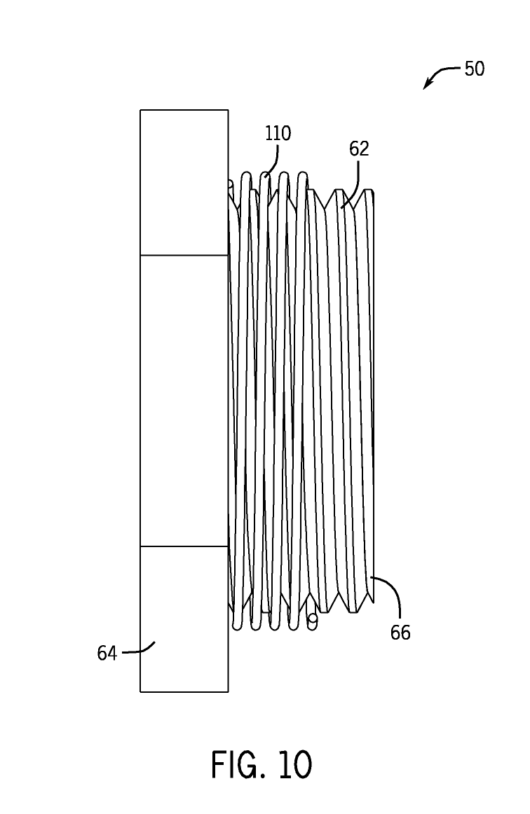

The plug 50 may incorporate additional features to determine how it applies compression to the cells 34. For example, as depicted in FIG. 10, the plug 50 may include a coil spring 110 to increase the compressive force applied to the cells 34 or allow limited movement of the cells 34 when they begin to expand. The coil spring 90 may fit between the inner surface of the casing 32 and the face of the end cell 34 or compression plate 80. The plugs 50 may include other components to facilitate compression, such as polymer gaskets, leaf springs, and other means of compression. Such compression components may be used when applying compression to the cells 34 is the primary goal of the housing system 30, as opposed to minimizing manufacturing costs and part count.

References herein to the positions of elements (e.g., “top,” “bottom,” “above,” “below,” etc.) are merely used to describe the orientation of various elements in the figures. It should be noted that the orientation of various elements may differ according to other embodiments, and that such variations are intended to be encompassed by the present disclosure.

It is important to note that the construction and arrangement of elements of the lithium-ion cell as shown in the various embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions, and arrangement of the various embodiments without departing from the scope of the present disclosure.

What is claimed is:

1. A housing system for one or more battery cells, the housing system comprising:
a casing forming a generally rectangular internal space, having opposing end pieces;
a hole extending through one of the end pieces; and
a plug having a head portion and a body portion, wherein the body portion is configured to extend through the hole to contact one of the battery cells, and the body portion having a detention mechanism to fix its position to provide a compressive force on the battery cells.

2. The housing system of claim 1, wherein the casing is configured to enclose multiple prismatic cells.

3. The housing system of claim 1, wherein the casing is of single-piece construction.

4. The housing system of claim 1, wherein the casing is formed of a plastic material.

5. The housing system of claim 1, wherein the hole is threaded and the detention mechanism of the plug comprises threads that match the threads of the hole to secure the plug at a desired axial position within the hole.

6. The housing system of claim 1, wherein the detention mechanism comprises a series of ribs disposed about the body of the plug and a snap ring that fits between the ribs to secure the plug at a desired axial position within the hole.

7. The housing system of claim 1, wherein the detention mechanism comprises a ratcheting mechanism having at least one set of triangular teeth disposed axially along the body portion of the plug and having at least one pawl to engage the teeth disposed about the hole of the end piece of the casing.

8. The housing system of claim 1, wherein the plug is configured to be placed within the hole and have torque applied to the head portion to apply a compressive force to the battery cells within the casing.

9. The housing system of claim 1, wherein the plug comprises a spring.

10. The housing system of claim 1 having a cooling system disposed below the casing, wherein the cooling system has direct access to the bottom of the cells.

11. The housing system of claim 1 having a compression plate, wherein the compression plate is generally rectangular, is located within the housing adjacent to the end piece having the hole, and is positioned between the body portion of the plug and the multiple prismatic cells.

12. The housing system of claim 1, wherein both end pieces of the casing include the hole and plug assembly.

13. The housing system of claim 12 having two rectangular compression plates, each located within the casing adjacent to each end piece and each compression plate is positioned between with the body portion of the plug and the multiple prismatic cells.

14. A battery module, comprising:
a casing having two side walls and two end walls forming a generally rectangular internal space and having a hole extending through the end wall;
a stack of battery cells, each being generally rectangular in shape and having a rigid container, the stack of battery cells fitting within the rectangular internal space of the casing; and
a plug having a head portion and a body portion, wherein the body portion is configured to extend through the hole to contact one of the battery cells, and the body portion having a detention mechanism to fix its position to provide a compressive force on the battery cells.

15. The battery module of claim 15 having a compression plate placed between the stack of electrochemical cells and the end wall of the casing having the hole, wherein the body portion of the plug is in contact with the compression plate.

16. The battery module of claim 14, having a cooling plate disposed below the casing, wherein the cooling plate is in contact with the bottom of each of the battery cells.

17. The battery module of claim 14, wherein both end walls include the hole and plugs and compression plates to correspond to each hole, each compression plate being positioned between an end wall and the stack of electrochemical cells.

18. The system of claim 14, wherein an xEV includes the battery module.

19. A method for applying compression to a stack of electrochemical cells using a rigid casing and at least one plug, comprising:
placing the stack of electrochemical cells within the rigid casing;
positioning the plugs within holes in the rigid casing; and
applying a desired amount of force to the plugs, wherein the plugs apply a compressive force to an end of the stack of electrochemical cells within the casing.

20. The method of claim 19, comprising fixing the plugs in place within the holes in the casing with a detention mechanism.
